(19) United States
(12) Patent Application Publication
(10) Pub. No.: US 2021/0163248 A1
(43) Pub. Date: Jun. 3, 2021

(54) Roller for the Transformation of Tape Material, In Particular for Paper Material

(71) Applicant: Guglielmo Biagiotti, Capannori (IT)

(72) Inventor: Guglielmo Biagiotti, Capannori (IT)

(21) Appl. No.: 16/624,736

(22) PCT Filed: Jul. 4, 2018
(86) PCT No.: PCT/IB18/54944

§ 371 Date: Dec. 19, 2019

(30) Foreign Application Priority Data
Jul. 4, 2017 (IT) 102017000074822

(51) Int. Cl. B65H 27/00

(52) U.S. Cl. CPC B65H 27/00; B65H 2404/1122; B65H 2515/81; B65H 2404/532; B65H 2404/18

(57) ABSTRACT

A roller (10) for converting tape material comprises a cylindrical pressure surface (11) defined by a coating element (21) made of resilient material of predefined hardness applied over a plurality of resilient annular pressure elements (15) made of elastic deformable material arranged axially side by side, so as to obtain an overall elastic yielding of the roller (10) independent from the superficial elastic yielding.

### TECHNICAL FIELD

The present invention relates to a roller of the type used in the processing machinery of tape material, in particular of the type suitable for cooperating through its side surface with the side surface of at least one further roller or other contrast surface, with the tape material to be treated that advances interposed between said surfaces.

### STATE OF THE ART

In the field of processing tape products, roller assemblies are widely used, arranged with parallel axes and substantially opposed two by two, so that through the pair of rollers the tape material advances interposed. The types of rollers are extremely varied, especially with regard to the shape and hardness of the surface, as a function of the treatment that the pair of rollers must operate on the tape material interposed between them.

In particular, for many types of work, such as for example lamination or embossing, it is advisable to have rollers which have a given overall elastic yielding and a given surface elastic yielding. In fact, while virtually, in the case of perfectly rigid rollers, the cooperation between two opposed rollers occurs along a line, in practice the overall elastic yielding of the roller allows an elastic deformation which allows to obtain a contact surface, called “nip”, as great as greater the rollers yielding and the pressure with which they are pushed towards each other are. In many processes it is important that the “nip” is sufficiently high for which a high overall yielding of the roll is sought. However, in the same processes it is often desirable to have a high surface hardness of the roller which must deform superficially as little as possible in the presence of reliefs or incisions of the surface of a corresponding roller with which it cooperates. Conventional rollers made of a steel support core coated with a high thickness of a homogeneous rubber material are not able to combine the aforementioned requirements since they can not have an overall elastic yielding different from the superficial elastic yielding.

The international application PCT/IB2017/051885, in the name of the same applicant, offers a solution to the abovesaid problem, in particular for the application in a pressing roller of a group of rollers used in the production of embossed paper rolls with nested methodology. The pressing roller of the aforementioned international application has a steel support core while the pressure surface is defined by the outer surface of a plurality of resilient annular pressure elements arranged side by side in an axial direction, each consisting of an annular body made of elastically deformable resilient material comprising an outer pressure ring the outer surface of which defines an axial portion of the cylindrical pressure surface, an inner ring mounted on the core and a plurality of connecting arms arranged and dimensioned to elastically connect the inner ring with the outer ring. Thanks to the aforementioned solution, the elastic resilient surface is extremely reduced, since the resilient material with which the annular bodies are made can have a very high hardness, while the overall elastic yielding remains very high as defined by the elastic structure of the annular bodies themselves and in particular the related connecting arms.

However, the aforementioned solution has limitations. First of all, the pressure surface of the roller is not perfectly uniform because it consists of the external surfaces of the annular bodies axially side by side. This can be a drawback in some specific applications where a perfect homogeneity of the cylindrical pressure surface is required. Moreover, the fact that the outer ring of the annular bodies determines the superficial yielding does not allow to achieve a complete independence of the overall elastic yielding from the superficial yielding.

### SUMMARY OF THE INVENTION

The object of the present invention is to propose a roller for the treatment of tape material capable of exceeding the limits described above of the rollers used in the prior art machines.

A specific object of the present invention is to propose a roller in which the superficial elastic yielding and the overall elastic yielding are independently defined according to the application requirements.

Another specific object of the present invention is to propose a pressing roller for the treatment of paper tape material with extremely low weight compared to the conventional pressing rollers in order to facilitate its dragging.

The aforesaid objects are achieved by means of a roller for the transformation of material in tape, in particular of the type used in cooperation with at least one further roller or other contrast surface so that said tape material interposed between the side surface of the roll and the lateral surface of the further roller or contrast surface, wherein the roller comprises at least one cylindrical pressure surface made of an elastically deformable material externally associated in a rotatably fixed manner to a cylindrical body mounted to rotate around its axis, and is characterized by the fact that the lateral pressure surface of the roller is defined by a resilient covering member applied to the outer surface of a plurality of resilient annular pressure elements arranged side by side in an axial direction, each of said resilient annular pressure elements being made up of an annular body made of an elastically deformable material comprising an outer pressure ring, an inner ring mounted on the cylindrical body of the roller and a plurality of connecting arms arranged and dimensioned for elastically connecting the inner ring with the outer ring.

The pressing roller described above has a continuous pressure surface whose surface yielding is determined by the material with which the coating element is made, while the overall yielding is determined by the material and by the structure of the annular pressure elements.

The roller of the invention allows to obtain deformable rollers having elasticity characteristics also very different from each other. From rollers that are generally very deformable but at the same time very hard on the surface, suitable for laminating or calendering processes, with rollers that are generally very deformable and soft surface, suitable for embossing thanks to the “nip” increase (compared to the rollers conventionally used for this operation) and consequently the processing time which allows the embossing roller pads to correctly deform the soft rubber surface of the roller even at the high speeds of today's machines.

### BRIEF DESCRIPTION OF THE DRAWINGS

These and other advantages and characteristics associated with the roller of the present invention, will become, however, more easily understood through the illustration of non-limiting examplifing embodiments, as described below with the aid of the enclosed drawings, in which:

FIG. 1 shows a schematic side sectional view of an axial end portion of a roller according to the present invention;

FIG. 2 is a sectional view taken on the line II-II of FIG. 1;

FIG. 3 is a schematic sectional view taken along the line III-Ill of FIG. 2;

FIG. 4 is a schematic view of a machine for producing paper products with two embossed and laminated layers according to the NESTED method comprising two rollers according to the present invention;

FIG. 5 is an enlarged view of the detail “X” of FIG. 4;

FIG. 6 is an enlarged view of the detail “Y” of FIG. 4.

### DESCRIPTION OF THE PREFERRED EMBODIMENTS

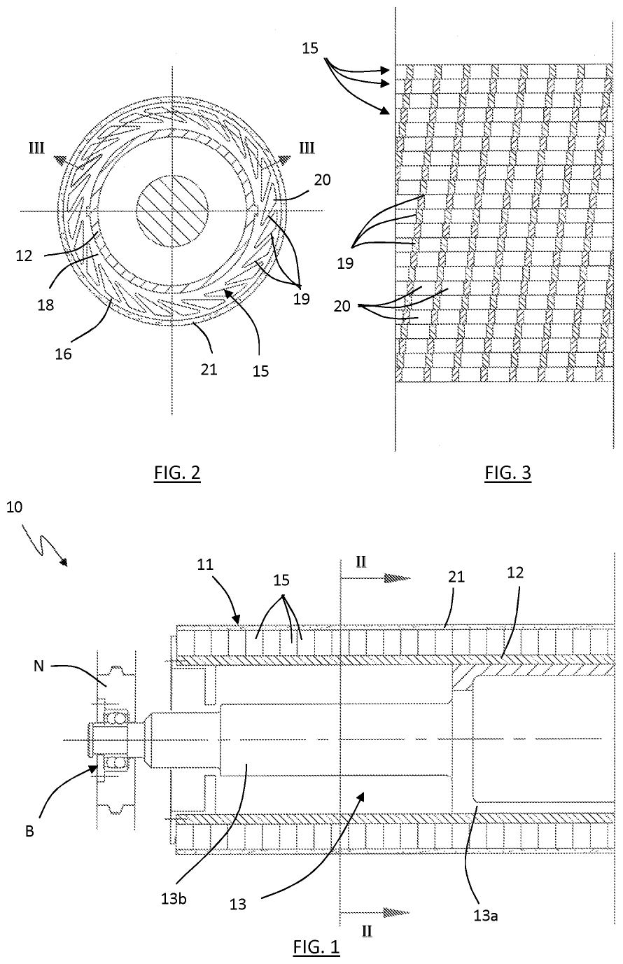

With reference to FIGS. 1 to 3, a roller 10, according to the present invention, is shown, which comprises a cylindrical side pressure surface 11 in this embodiment.

The roller 10 comprises a cylindrical tubular, 12, extending axially for the entire axial length of the roller 10, mounted coaxially, in rotatably fixed mode, outside two revolving end support bodies, 13 (of which is shown in FIG. 3 only the one on the left end of the roller 10). In the embodiment of FIG. 3 each revolving end support body 13 is composed of a tubular portion, 13a, to the outer surface of which is associated the cylindrical tubular 12 and a solid shaft portion, 13b, one end of which protrudes axially from the cylindrical tubular 12 and is arranged to be rotatably supported by support members, N, through the interposition of rolling bearings, B.

Externally, in a radial direction, a plurality of resilient annular pressure elements 15 are mounted to the cylindrical tubular 12, arranged side by side in an axial direction, coaxially mounted on the outer surface of the cylindrical tubular 12 in a rotatably fixed manner.

Each resilient annular pressure element 15 is made of a single body of elastically deformable material of hardness preferably greater than 70 ShA and comprises an outer pressure ring 16, an inner ring 18, mounted on the cylindrical tubular 12 of the cylindrical body and a plurality of connecting arms, 19, arranged and dimensioned for elastically connecting the inner ring 18 with the outer pressure ring 16.

The connecting arms 19 are arranged inclined with respect to the radial direction and form separation septa between a plurality of axial cavities, 20, made between the inner ring 18 and the outer pressure ring. Together with the characteristics of the elastically deformable material with which the resilient annular pressure element 15 is made, the dimensions of the cavities 20 and of the connecting arms 19 and the inclination of the latter define the properties of the overall elastic yielding of the portion of the roller 10 defined by the annular pressure element 15 itself.

In fact, because of the material of which they are made and of their sizing, the connecting arms 19 tend to bend in the plane orthogonal to the axis of the roller 10, with consequent deformation in the same plane of the outer pressure ring 16 which assumes a radially corrugated shape but does not deform in the axial direction nor it moves in this direction with respect to the inner ring 18.

According to a preferred embodiment, the resilient annular pressure elements 15 are made of elastomeric material of suitable hardness, as mentioned above preferably of 70 ShA, and their deformability is defined by suitably dimensioning the length, thickness and inclination of the relative connecting arms 19. Alternatively, the resilient annular pressure elements are made of materials having a high elasticity module but with a much greater hardness, such as for example the harmonic steel, and the desired deformability is provided by providing a substantially lower thickness of the relative connecting arms 19 and of the outer pressure ring 16 with respect to the embodiments in which the annular pressure elements 15 are made of elastomer.

As can be seen from the schematic section of FIG. 3, all the annular pressure elements 15 are identical to each other, but each resilient annular pressure element 15 is mounted angularly offset with respect to the adjacent ones of the same entity so as to provide a cylindrical lateral surface of the roller 10 with substantially uniform overall elasticity.

Externally to the outer ring 16 of the annular pressure elements 15 there is a coating element 21, made of resilient material, of suitable thickness, which extends to substantially cover the entire lateral surface of the roller 10, and whose outer surface constitutes the pressure surface 11 of the roller 10. The coating element 21 is applied around the annular pressure elements 15 directly by vulcanization of a rubbery material, or by gluing or by other techniques.

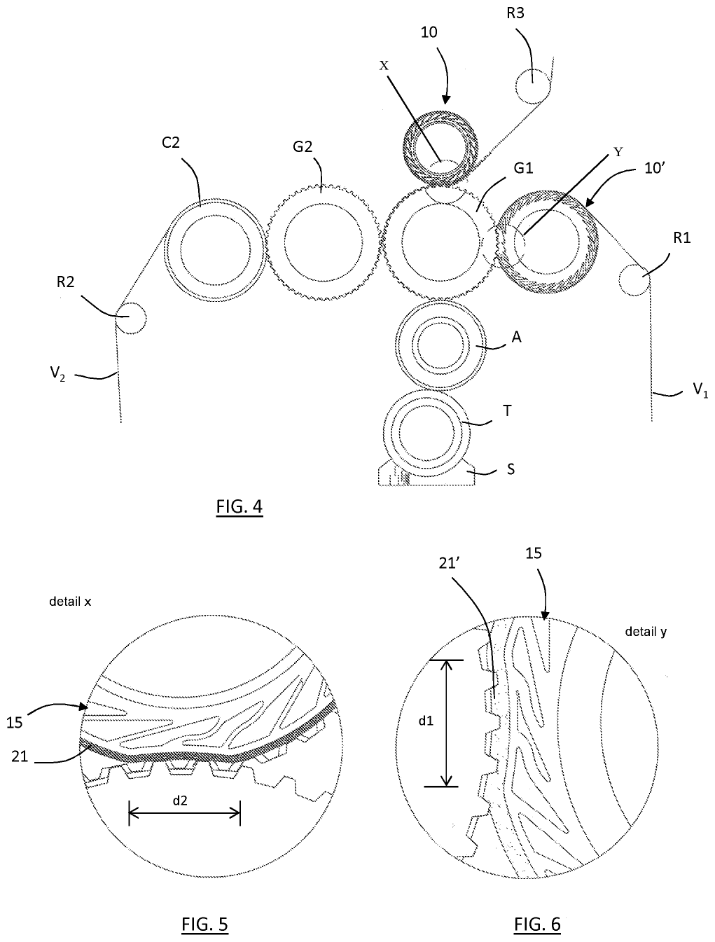

With reference to FIG. 4, the roller 10 above described is advantageously used in a process for the realization of two-ply embossed paper with NESTED pairing type in which a first, V1, and a second, V2, ply of tissue paper are dragged by a group of rollers which perform the embossing, the pairing and the bonding of the two plies. More specifically, each ply crosses a relative deflection roller, R1, R2, a relative contrast roller, C1, C2, and a relative engraving roller, G1, G2, provided with an embossed surface pattern, the interaction among which performs the NESTED pairing of the two plies V1 and V2. In correspondence of a first engraving roller G1 is present a group of glue application comprising a glue tank, S, in which catches a roller pad, T, which transfers the glue to an applicator roller, A, which applies the glue on the surface of the first ply V1. Before leaving the first engraving roll G1 the two paired paper plies are pressed one against the other by a pressing roller, P, which acts against the first engraving roll G1 itself to allow the glue to fasten together the two plies before exiting the machinery through a further deflection roller, R3.

In the group described above a first contrast roller 10′ and the pressing roller 10 are rollers according to the present invention.

As shown in the detail Y of FIG. 6, the “nip” between the engraving roller G1 and the contrast roller 10′, equal to the value d1, is high due to the high overall elastic yielding of the contrast roller 10′ conferred by the presence of the annular pressure elements 15. At the same time the engraving of the decorative pattern in the paper takes place effectively thanks to the high superficial yielding of the contrast roller 10′ conferred by the coating element 21′, which has advantageously hardness comprised between 30 ShA and 70 ShA and thickness suitable for embossing the decorative pattern in the paper tape product to be treated. In this case the high “nip” that is obtained allows a longer time of treatment of the veil which allows the resilient coating to deform obtaining a better embossing height compared to a traditional rubber roller.

As shown in the detail “X” of FIG. 5, the “nip” between the engraving roller G1 and the pressing roller 10, equal to the value d2, is also high thanks to the high overall elastic yielding of the contrast roller 10 conferred by the presence of the annular pressure elements 15. At the same time the re-embossing effect is completely avoided, thanks to an extremely reduced elastic surface yielding conferred by the high hardness of the resilient material with which the coating element 21 is formed which defines the pressure surface 11, advantageously superior to 70 ShA. Moreover, the coating element 21 provides a side pressure surface 11 free of discontinuity without the necessity of providing a very precise side-by-side arrangement of the annular pressure elements 15.

Moreover, in both cases, thanks to the lightness of the roller and to the elastic yielding of the resilient annular pressure elements 15, the pressure with which it is necessary to press the rollers 10, 10′ against the engraving roller G1 to obtain a large nip and a good drag of the roller itself is extremely modest compared to that required with conventional rollers. Thanks to this, the cylindrical body on which the annular pressure elements 15 are mounted can be of extremely simple and lightweight construction because it may not have the characteristics of robustness and flexural rigidity with which the conventional pressure rollers must be equipped in order to withstand the high pressures of contact.

It is certainly easy to understand that the application examples described above are merely illustrative of the peculiarity and versatility of a roller according to the present invention whose use can be advantageous whenever it is desirable a roll having a continuous side surface and with an overall elastic yielding and a superficial yielding of the roller completely independent from one another, without significant increase in production costs. For example, a roller according to the present invention can advantageously be used not only in applications in which it cooperates with a further roller, but also in association with flat surfaces, such as for example belt conveyors ones.

Obviously many variations to the roller structure of the invention described above by way of example are within the reach of a technician of the sector without this having to employ any inventive activity, such as for example the possibility of realizing a roller according to the invention in which the surface of pressure 11 is not cylindrical but concave, with a barrel, or with another arbitrary profile, or that the structure described is applied only on an axial portion of a roll which is overall longer than the portion which presents the structure according to the present invention.

In fact, the above made description of specific embodiments is useful to illustrate the invention core concept, in such a way that experts in the field may implement it modifying and adapting the above said embodiments to the various applications; such adaptations and modifications will therefore be considered as equivalent to the exemplified embodiments. It is understood that the phraseology or numbering used have purely descriptive and aid purposes for understanding the inventive concept and therefore are not limiting.

1.-8. (canceled)

9. A roller for the transformation of material in tape of the type used in cooperation with at least one further roller or other contrast surface so that the tape material is interposed between the side surface of the roller and the side surface of the further roller or the contrast surface, wherein the roller comprises at least one pressure surface made of an elastically deformable material externally associated in a rotatably fixed manner to a cylindrical body mounted to rotate around its axis, wherein the side pressure surface is defined by a coating element made of a resilient material applied on an outer surface of a plurality of resilient annular pressure elements arranged side by side in an axial direction, each of the resilient annular pressure elements including an annular body made of an elastic deformable material, comprising an outer ring, an inner ring mounted on the cylindrical body, and a plurality of connecting arms arranged inclined with respect to a radial direction and dimensioned for elastically connecting the inner ring with the outer ring.

10. The roller for the transformation of tape material according to claim 9, wherein the coating element is made of a resilient material having a hardness greater than 70 ShA.

11. The roller for the transformation of tape material according to claim 9, wherein the coating element is made of a resilient material having a hardness between 30 ShA and 70 ShA.

12. The roller for the transformation of tape material according to claim 9, wherein the coating element is associated with the roller by vulcanization,

13. The roller for the transformation of tape material according to claim 9, wherein the connecting arms are arranged inclined with respect to the radial direction.

14. The roller for the transformation of tape material according to claim 9, wherein each of the resilient annular pressure elements is mounted angularly staggered with respect to adjacent resilient annular pressure elements so as to achieve a substantially uniform elastic yielding of the pressure surface.

15. The roller for the transformation of paper tape material according to claim 9, wherein the cylindrical body is made of a lightweight material including any of one of aluminum or carbon fiber.

16. The roller for the transformation of paper tape material according to claim 9, wherein the resilient annular pressure elements are made of an elastically deformable material having a hardness greater than 70 ShA.
